(19) United States
(12) Patent Application Publication
(10) Pub. No.: US 2007/0277909 A1
(43) Pub. Date: Dec. 6, 2007

(54) Solder Paste and Electronic Device Using Same

(76) Inventors: Norihito Tsukahara, Kyoto (JP); Kazuhiro Nishikawa, Osaka (JP)

Correspondence Address: MCDERMOTT WILL & EMERY LLP, 600 13TH STREET, NW, WASHINGTON, DC, 20005-3096, US

(21) Appl. No.: 11/660,552

(22) PCT Filed: Sep. 6, 2005
(86) PCT No.: PCT/JP05/16291

§ 371 Date: Feb. 20, 2007

(30) Foreign Application Priority Data
Sep. 13, 2004 (JP) 2004-265148

(51) Int. Cl. B23K 35/34

(52) U.S. Cl. 148/24

(57) ABSTRACT

This invention provides such solder paste that prevents, when a minute-size passive component or a semiconductor integrated circuit element having a small terminal pitch is soldered by the solder paste, the solder particles from being oxidized to provide highly-reliable solder joint even when the solder paste is used in a very small amount. Specifically, solder paste obtained by mixing solder alloy powders with flux is structured so that the flux has, at a pre-heating temperature in a heating/melting step, a high temperature retention property by which the flux covers the surface of the solder alloy powders.

### TECHNICAL FIELD

The present invention relates to solder paste used in the field of electronic devices. In particular, the present invention relates to solder paste for subjecting minute electronic components to solder joint to various substrates and an electronic device using the solder paste.

### BACKGROUND ART

Recently, for the purpose of providing an electronic device having a smaller size and a lighter weight, a technique has been used that uses solder paste to package, with a high density, a surface-mounted electronic component on a print wiring substrate having thereon a fine pattern.

This technique uses such solder paste that is prepared by mixing about 80 to 90% by weight solder fine powders having a particle size of few dozens of μm and about 10 to 20% by weight flux consisting of rosin, solvent, activator, thixotropic agent or the like to provide paste-like mixture. This solder paste has a viscosity adjusted to be suitable for a screen printing.

Solder paste is mainly used for the purpose of connecting an electronic component (e.g., semiconductor element, resistance, capacitor) onto a print wiring substrate. Solder paste is generally packaged by the method as described below. First, an appropriate amount of solder paste is coated on a copper foil land as a connection terminal of a print wiring substrate by a screen printing, a dispenser or the like. Next, a to-be-packaged electronic component is mounted on the copper foil land coated with the solder paste by an automatic packaging machine for example. It is noted that the electronic component mainly may be a surface-mounted electronic component (e.g., the so-called passive component, semiconductor integrated circuit element). Thereafter, the electronic component mounted on the copper foil land coated with the solder paste is heated and to melt the solder paste by a heating apparatus (e.g., reflow furnace, infrared irradiation apparatus, laser irradiation apparatus) to joint the copper foil land of the print wiring substrate with the electrode terminal section of the electronic component, thereby completing the packaging step.

These surface-mounted electronic components have been developed to have a higher function and an ultrasmall size with the advent of smaller and more sophisticated electronic devices such as a mobile phone. For example, the size of passive components such as a chip resistance and a chip capacitor has been changed from the conventional 1608 size to a 1005 size and has been recently changed to a 0603 size for practical use. It is assumed that the size will be further reduced to a 0402 size. Furthermore, semiconductor integrated circuit elements tend to have a greater number of terminals. However, an increased package size for accommodating a greater number of terminals is not preferable. Thus, a narrower terminal pitch has been required.

With a smaller passive component and a narrower terminal pitch of a semiconductor integrated circuit as described above, these electronic components have an electrode terminal section having a smaller area. For example, a case will be considered where a chip resistance or a chip capacitor having a 1608 size is coated based on conditions where a soldering region having an area of 100 is coated with solder paste in an amount of 100. When this case with compared with a case where a 1005 size is coated based on the same conditions, an area ratio of the 1005 size to the 1608 size is about 0.5 and the ratio of the coating amount of the 1005 size to the 1608 size is about 0.3. When the same applies to a 0603 size, an area ratio of the 0603 size to the 1608 size is about 0.2 and the ratio of the coating amount of the 0603 size to the 1608 size is about 0.07. Thus, solder joint of a 0603-size electronic component to a terminal of a print wiring substrate requires solder paste to be coated in a significantly smaller amount than that for a conventional size. This means a risk where such a small-size electronic component may be soldered with insufficiently-melted solder by conventional soldering conditions under which larger size electronic components have been stably soldered. In this case, solder balls or the like may be caused and a defective joint may be caused.

The same risk also applies to a semiconductor integrated circuit element. For example, a problem has been found in which a narrower pitch for coping with an increased number of terminals also requires a smaller soldering area.

With regards to a trend for the composition of solder paste on the other hand, the so-called copper solder including Pb—Sn alloy as a major component conventionally used from a viewpoint of environmental preservation has been increasingly substituted by copper-free solder (i.e., Sn—Zn base alloy, Sn—Ag base alloy, Sn—Ag—Cu base alloy).

When these solder materials are used for solder an electronic component to a wiring substrate, the solder material sandwiched by the electronic component and the wiring substrate is firstly pre-heated in a reflow furnace at a temperature of 140 to 180 degrees until the solder material is heated to a solder temperature of 200 to 280 degrees at which the solder is melted. During this pre-heating process, flux at the uppermost surface flows among solder particles to prevent the solder particles at the surface layer from being covered by flux, thereby causing the solder particles to be directly exposed to air. This causes the solder particles at the surface layer to be oxidized. Thus, even when most solder particles in the solder paste are melted and are integrated, those solder particles having an oxidized surface are not melted and not integrated to subsequently form a solder ball. This solder ball causes a short circuit failure or the like. Furthermore, a minute-size passive component and a semiconductor integrated circuit element having a narrow terminal pitch as described above require a very small amount of solder paste. Thus, the existence of a solder ball that is not effectively used for a soldering process causes a defective solder or a lower reliability for a soldered portion.

A solder ball has been prevented by a conventional method as disclosed by Japanese Patent Unexamined Publication No. H06-7989. According to this method, a solder ball is caused by sagged solder paste during a pre-heating process and this sagging is prevented by solder paste in which flux is added with a fluorine compound for example.

Japanese Patent Unexamined Publication No. 2000-107887 discloses a method for using flux including nitrogen gas-causing material (e.g., sodium nitrite) to cause, during a pre-heating process, solder particles to be surrounded by nitrogen gas atmosphere to prevent the oxidation. According to this method, only a solder region can be surrounded by nitrogen gas atmosphere even when a reflow furnace is used in air and thus the solder particles can be prevented from oxidized.

According to the first example, flux is added with a fluorine compound to prevent solder paste during a pre-heating process from being sagged to prevent a solder ball. When flux flows during a pre-heating process, the solder particles also flow and diffuse in an area larger than an area to be printed and coated, thereby causing solder sagging. In addition, the diffused solder particles do not melt while most solder particles being melted and subsequently form a solder ball. This phenomenon is prevented by adding a fluorine compound to flux. However, in the case of an ultrasmall component such as a 0603 size passive component, an area coated with solder paste is very small to cause a very small coating amount of solder paste and thus the sagging as described above rarely occurs. Thus, the only prevention of the sagging may not be able to prevent a solder ball caused in a very small amount of solder.

According to the second, example, nitrogen gas-causing material is included in flux so that solder particles can be surrounded by nitrogen gas atmosphere during a pre-heating process. Although this method is effective for a conventional coating amount of solder paste, this method may not sufficiently prevent the oxidation of a very small coating amount of solder paste because the solder paste in such a small coating amount causes a small amount of nitrogen gas.

### SUMMARY OF THE INVENTION

This invention provides such solder paste that prevents, when a minute-size passive component or a semiconductor integrated circuit element having a small terminal pitch is soldered by the solder paste, the solder particles from being oxidized to provide highly-reliable solder joint even when the solder paste is used in a very small amount. The solder paste of the present invention is obtained by mixing solder alloy powders with flux and is structured so that the flux has, at a pre-heating temperature in a heating/melting step, a high temperature retention property by which the flux covers the surface of the solder alloy powders.

This structure prevents the solder alloy powders to be covered by the flux until a pre-heating temperature is reached to prevent the solder alloy powders from being exposed to air. Thus, the surface of the solder alloy powders can be prevented from being oxidized. This prevents, even when the solder paste is used for a 0603-size electronic component using a very small amount of solder paste or a semiconductor integrated circuit element connected with a narrow pitch, a solder ball from being caused to provide highly-reliable joint.

Furthermore, the electronic device of the present invention is structured to include a circuit substrate packaged with an electronic component. In the electronic device, solder paste for solder-joining the electronic component to the circuit substrate is the solder paste as described above. It is noted that an electronic component includes a passive component such as a chip resistance or a chip component and a functional component such as a semiconductor integrated circuit element or a sensor.

This structure allows a minute size chip component or a minute pitch semiconductor element or the like, which has conventionally been difficultly packaged with high reproducibility, to be packaged with high reproducibility and in a stable manner. Thus, an electronic device having a smaller size can be realized.

### BRIEF DESCRIPTION OF THE DRAWINGS

FIG. 1A is a schematic view illustrating the heating behavior of solder paste when the solder paste is coated in a coating amount corresponding to a 1005-size chip component.

FIG. 1B is a schematic view illustrating when the solder paste in the coating amount corresponding to a 1005-size chip component is pre-heated.

FIG. 1C is a schematic view illustrating the melting status of the solder when the solder paste in the coating amount corresponding to a 1005-size chip component is heated to a peak temperature at which the solder is melted.

FIG. 2A is a schematic view illustrating the heating behavior of the solder paste in the coating amount corresponding to a 0603-size chip component.

FIG. 2B is a schematic view illustrating the status of the solder paste in the coating amount corresponding to a 0603-size chip component.

FIG. 2C is a schematic view illustrating the melting status of the solder paste when the solder in the coating amount corresponding to a 0603-size chip component is heated to a peak temperature at which the solder melts.

FIG. 3 is a cross-sectional view illustrating an electronic circuit substrate for a mobile phone prepared by using the solder paste of Illustrative Embodiment 1.

FIG. 4 is a perspective view illustrating a mobile phone using the electronic circuit substrate shown in FIG. 3.

### REFERENCE MARKS IN THE DRAWINGS

10 Electrode terminal
20, 200 Solder paste
22, 220 Solder particle
24, 240 Flux
26, 260 Solder particle having oxidized film
30, 300 Solder after melting
410 Multilayer wiring substrate
412, 414 Chip component
416 Semiconductor chip
420 Chassis
422 Display element
424 Button

### DETAILED DESCRIPTION OF PREFERRED EMBODIMENTS

Hereinafter, embodiments of the present invention will be described.

When flux for solder paste is prepared, the respective materials constituting the flux are generally mixed and heated to provide mixture solution. However, this embodiment uses heat-curing polymer material for which the viscosity increases in an irreversible manner when the material is heated. Thus, the respective materials of solder paste in this embodiment are kneaded in a room temperature and are subjected to a uniform solution mixing to provide flux solution. It is noted that this embodiment will be described based on an assumption that heat-curing polymer includes thermosetting resin.

How to prepare solder paste according to this embodiment will be described. First, pine resin-base resin, thixotropic agent, activator, and solvent as a flux component are mixed to provide binder. Then, the binder is mixed with solder alloy powders having a particle size of 10 to 40 μm to provide paste-like mixture. Then, the paste-like mixture is added with heat-curing polymer having the viscosity that increases at a high temperature.

In this embodiment, conventional pine resin-base resin, thixotropic agent, activator, and solvent can be used. For example, pine resin-base resin may be WW rosin, polymerized rosin, hydrogenerated rosin or the like. Thixotropic agent may be stearylamide, hydrogenated ricinus or the like. Activator may be diphenylguanidine HBr, cyclohexylamine HBr, adipic acid, sebacic acid, or the like. Solvent may be butyl carbitol, propylene glycol, hexylene glycol, a-telpionel or the like. Thus, conventionally-used solvents may be used separately or may be used in combination.

Solder paste according to this embodiment is prepared by a method as described below. Specifically, the above flux components are heated and melted to provide solution. Then, the solution is cooled to a temperature equal to or lower than a room temperature. Then, the solution is added and mixed with heat-curing polymer material (e.g., epoxy resin) so that the solution obtains a high temperature retention property by which the flux can cover solder alloy powders (hereinafter may be referred to as solder particles) until a pre-heating temperature is reached. Alternatively, the solution is added with thickener for suppressing the flux from having a reduced viscosity at a high temperature so that the surfaces of the solder particles are covered by the flux even at a pre-heating temperature. These fluxes are uniformly mixed with solder particles as a solder component selected from Sn—Ag—Cu, Sn—Ag—In—Bi, Sn—Zn—Bi, and Sn—Ag—Cu—Bi for example, thereby preparing solder paste. It is noted that flux is preferably mixed with solder alloy powders with a ratio of flux of 7 to 13% by weight to solder alloy powders of 87 to 93% by weight.

The flux also may be prepared so as to have a viscosity during a pre-heating process that is equal to or higher than the viscosity at a room temperature. This suppresses the flux from being flowed out even at a pre-heating temperature. Thus, solder alloy powders can be securely covered by the flux to prevent the powders from being oxidized.

The flux also may include heat-curing polymer material. This heat-curing polymer material may be selected from polyester resin, methyl methacrylate resin, epoxy resin, polystyrene resin, phenol resin, and drying oil. The use of the material as described above allows the flux to have a high viscosity during a pre-heating process, thus effectively suppressing a solder ball from occurring.

The above flux having a viscosity at 140 to 180 degrees that is 70% or more of the viscosity at a room temperature can securely coat the surfaces of solder alloy powders at a pre-heating temperature to effectively suppress the solder particles from being oxidized. Since the flux has a relatively high viscosity in this temperature range, the flux may be effectively used for not only generally used copper-free solder (e.g., Sn—Ag—Cu base alloy solder, Sn—Zn base alloy solder, or Sn—Ag base alloy solder) but also conventional copper solder to provide solder paste. It is noted that, although solder material that melts at a lower temperature than the case of these materials also may be mixed with the above flux to provide solder paste, such solder material requires a pre-heating process to be performed with a relatively low temperature and thus suppresses solder alloy powders from being oxidized. Thus, the above flux cannot provide, when being used with such solder material, a remarkable effect as in solder material melting at a high temperature.

The flux also may include thickener including polymer including a thixotropic nature. This polymer may be at least one of carboxy vinyl polymer, alginate sodium, propylene glycol alginate, ethyl cellulose, carboxymethylcellulose, synthetic sodium magnesium silicate, dimethyl distearyl ammonium hectolite, sodium polyacrylate, hydroxy ethyl cellulose, and hydroxy propyl methylcellulos. This can suppress the viscosity from changing at a high temperature.

Furthermore, the flux in an amount of 20% by weight also may be included in solder paste. This can securely prevent solder alloy powders from being oxidized during a pre-heating process. When the flux in an amount of 15% by weight or less is included in solder paste, the oxidation can be prevented and the resulting solder paste can have a superior print characteristic. When the flux in an amount of 11% by weight or less is included in solder paste, it provides a relatively large amount of solder alloy powders. Thus, even when the solder paste in a very small amount is coated, solder alloy powders can mutually melt in a secure manner, thereby further suppressing a solder ball from occurring.

Furthermore, solder alloy powders may be made of any of Sn—Ag—Cu base alloy, Sn—Ag—In—Bi base alloy, Sn—Zn—Bi base alloy, and Sn—Ag—Cu—Bi base alloy. This provides, even when such powders are included in copper-free solder paste, such a solder joint that has a superior solder property in a minute region and that provides high reliability.

The electronic device of the present invention is characterized in having a structure including a circuit substrate on which an electronic component is packaged and solder paste for solder-joining the electronic component to the circuit substrate is the above-described solder paste. It is noted that an electronic component includes a passive component such as a chip resistance or a chip component and a functional component such as a semiconductor integrated circuit element or a sensor.

This structure allows a minute size chip component or a minute pitch semiconductor element or the like, which has conventionally been difficultly packaged with high reproducibility, to be packaged with high reproducibility and in a stable manner. Thus, an electronic device having a smaller size can be realized.

It is noted that the electronic device of the present invention may be effectively applied to a mobile electronic device that is particularly required to have a smaller size and a more sophisticated function (e.g., mobile phone, mobile information device, notebook computer, audio recording device, video camera, digital camera, car navigation system). However, the electronic device of the present invention is not limitedly applied to them. The electronic device of the present invention is not limitedly applied to a particular apparatus and also can be used for an image receiving apparatus (e.g., laptop personal computer, personal computer), various home electric appliances, professional electrical products or the like.

As described above, the solder paste of the present invention can effectively suppress the surface of solder alloy powders from being oxidized, thus providing a strong soldering between an electrode terminal on a print wiring substrate and an electrode of an electronic component. The solder paste of the present invention also can suppress a solder ball caused during a packaging process for example, thus preventing a short circuit between terminals to provide a high connection reliability.

Next, illustrative embodiments of the solder paste in this embodiment will be described.

### Illustrative Embodiment 1

Solder paste was prepared by flux of 8% by weight and solder alloy powders (Sn—Ag—Cu) of 92% by weight. It is noted that the flux is composed of the following components.

| | |
|---|---|
| Polymerized rosin | 52% by weight |
| Hydrogenated ricinus | 5% by weight |
| Diphenylguanidine HBr | 2% by weight |
| a-telpionel | 33% by weight |
| Epoxy resin | 8% by weight |

Furthermore, curing agent of epoxy resin composed of acid anhydride and polyamide was added in a required amount to the solder paste. This provides the solder paste with a viscosity adjusted so that the flux covers the surface of solder particles even when at a pre-heating temperature during a reflow soldering operation.

### Illustrative Embodiment 2

Solder paste was prepared by flux of 10% by weight and solder alloy powders (Sn—Ag—Cu) of 90% by weight. It is noted that the flux is composed of the following components.

| | |
|---|---|
| Polymerized rosin | 46% by weight |
| Stearylamide | 4% by weight |
| Cyclohexylamine HBr | 2% by weight |
| a-telpionel | 40% by weight |
| Polyester resin | 8% by weight |

Furthermore, curing agent of polyester resin in which benzoyl peroxide and lauryl peroxide are added with an appropriate amount of catalyst such as cobalt naphthenate. This provides, as in Illustrative Embodiment 1, the solder paste with a viscosity adjusted so that the flux covers the surface of solder particles even when at a pre-heating temperature during a reflow soldering operation.

### Illustrative Embodiment 3

Solder paste was prepared by flux of 8% by weight and solder alloy powders (Sn—Ag—Cu—Bi) of 92% by weight. It is noted that the flux is composed of the following components.

| | |
|---|---|
| Polymerized rosin | 40% by weight |
| Hydrogenated ricinus | 5% by weight |
| Diphenylguanidine HBr | 2% by weight |
| a-telpionel | 23% by weight |
| Butyl carbitol | 20% by weight |
| Styrene monomer | 10% by weight |

Furthermore, curing catalyst of styrene monomer composed of benzoyl peroxide was added to the solder paste. This provides, as in Illustrative Embodiment 1 and Illustrative Embodiment 2, the solder paste with a viscosity adjusted so that the flux covers the surface of solder particles even when at a pre-heating temperature during a reflow soldering operation.

### Illustrative Embodiment 4

Solder paste was prepared by flux of 11% by weight and solder alloy powders (Sn—Ag—Cu) of 89% by weight. It is noted that the flux is composed of the following components.

| | |
|---|---|
| Polymerized rosin | 40% by weight |
| Hydrogenated ricinus | 5% by weight |
| Cyclohexylamine HBr | 2% by weight |
| a-telpionel | 33% by weight |
| Hexylene glycol | 10% by weight |
| Methyl methacrylate resin | 10% by weight |

Furthermore, curing catalyst of methyl methacrylate resin composed of benzoyl peroxide was added to the solder paste. This provides, as in Illustrative Embodiment 1 to Illustrative Embodiment 3, the solder paste with a viscosity adjusted so that the flux covers the surface of solder particles even when at a pre-heating temperature during a reflow soldering operation.

As shown in Illustrative Embodiment 1 to Illustrative Embodiment 4, the solder paste according to this embodiment is desirably prepared by kneading flux of 8 to 11% by weight and solder alloy powders of 89 to 92% by weight at a temperature equal to or lower than a room temperature. This solder paste is preferably stored at a room temperature or less. It is noted that this solder paste includes solder alloy powders having a particle size of 10 to 30 μm.

It is noted that, in order to provide a high temperature retention property by which the flux covers the solder particles until the pre-heating temperature is reached, phenol resin or drying oil other than the materials described in the above illustrative embodiments also can be used.

Next, an illustrative embodiment will be described in which the above basic components of the flux are added with thickener for suppressing the flux from having a lowered viscosity at a high temperature so that the surface of the solder particles can be covered by the flux even at a pre-heating temperature.

### Illustrative Embodiment 5

Solder paste was prepared by flux of 8% by weight and solder alloy powders (Sn—Ag—Cu) of 92% by weight. It is noted that the flux is composed of the following components.

| | |
|---|---|
| Polymerized rosin | 48% by weight |
| Hydrogenated ricinus | 5% by weight |
| Diphenylguanidine HBr | 2% by weight |
| Hexylene glycol | 25% by weight |
| Butyl carbitol | 20% by weight |

Furthermore, the above flux of 100% by weight was added with carboxy vinyl polymer of 0.3% by weight.

### Illustrative Embodiment 6

Solder paste was prepared by flux of 10% by weight and solder alloy powders (Sn—Ag—Cu) of 90% by weight. It is noted that the flux is composed of the following components.

| | |
|---|---|
| Polymerized rosin | 48% by weight |
| Hydrogenated ricinus | 6% by weight |
| Diphenylguanidine HBr | 3% by weight |
| a-telpionel | 43% by weight |

Furthermore, the above flux 100% by weight was added with synthetic sodium magnesium silicate of 0.1% by weight.

### Illustrative Embodiment 7

Solder paste was prepared by flux of 9% by weight and solder alloy powders (Sn—Ag—Cu) of 91% by weight. It is noted that the flux is composed of the following components.

| | |
|---|---|
| Polymerized rosin | 48% by weight |
| Hydrogenated ricinus | 6% by weight |
| Diphenylguanidine HBr | 3% by weight |
| a-telpionel | 43% by weight |

Furthermore, the above flux of 100% by weight was added with hydroxy ethyl cellulose of 0.5% by weight.

It is noted that, in addition to the thickeners in the above illustrative embodiments, at least any of alginate sodium, propylene glycol alginate, ethyl cellulose, carboxymethylcellulose, dimethyl distearyl ammonium hectolite, sodium polyacrylate, and hydroxy propyl methylcellulos also can be used.

Next, for the comparison with the solder pastes prepared in Illustrative Embodiment 1 to Illustrative Embodiment 7 of the present invention, conventional solder paste was prepared in a manner as described below as a comparison example in which flux flows or vaporizes at a pre-heating temperature.

### COMPARISON EXAMPLE 1

Solder paste was prepared by flux of 10% by weight and solder alloy powders (Sn—Ag—Cu) of 90% by weight. It is noted that the flux is composed of the following components.

| | |
|---|---|
| Polymerized rosin | 50% by weight |
| Hydrogenated ricinus | 5% by weight |
| Diphenylguanidine HBr | 2% by weight |
| a-telpionel | 43% by weight |

### COMPARISON EXAMPLE 2

Solder paste was prepared by flux of 11% by weight and solder alloy powders (Sn—Ag—Cu) of 89% by weight. It is noted that the flux is composed of the following components.

| | |
|---|---|
| Polymerized rosin | 48% by weight |
| Hydrogenated ricinus | 5% by weight |
| Diphenylguanidine HBr | 2% by weight |
| Hexylene glycol | 25% by weight |
| Butyl carbitol | 20% by weight |

The above-described solder pastes according to Illustrative Embodiment 1 to Illustrative Embodiment 7 and Comparison Example 1 to Comparison Example 2 were used to solder 1005-size chip resistances and 0603-size chip resistances onto print wiring substrates. Then, these solder pastes were evaluated for the melting status and the existence or non-existence of a solder ball. Specifically, solder coating amount to a 0603-size chip resistance is required to be about ¼ smaller than the solder coating amount to a 1005-size chip resistance. Thus, the above seven types of solder pastes of Illustrative Embodiments 1 to 7 and the two types of solder pastes of Comparison Examples 1 and 2 were coated, in the respective required amounts, on the above two types of 0603-size chip resistance and 1005-size chip resistance chip resistances in order to observe the melting statuses of the solder pastes by heating and whether a solder ball is caused or not. It is noted that the observation was performed in the manner as described below. Specifically, a print wiring substrate coated with solder paste was placed in a heating section of a high temperature microscope to heat the substrate under the reflow conditions as described below to evaluate the change of the solder paste during the heating process. According to the reflow conditions, the print wiring substrate coated with solder paste is heated from a room temperature for 60 seconds until 180 degrees as a pre-heating temperature are reached and then is retained at 180 degrees for 60 seconds. After pre-heating, the print wiring substrate was heated to 245 degrees as a peak temperature and was retained for 10 seconds in this condition and is subsequently cooled. In this manner, the melting status and the existence of non-existence of a solder ball the solder paste was observed while the solder paste being heated. It is noted that the heating was performed in air atmosphere.

TABLE 1

| | Coating amount corresponding to | | | | Coating amount corresponding to | | | |
|---|---|---|---|---|---|---|---|---|
| | 1005-size chip resistance | | | | 0603-size chip resistance | | | |
| | | Peak of | After | | | Peak of | After | |
| | Pre-heating | heating | cooling | Evaluation | Pre-heating | heating | cooling | Evaluation |
| Illustrative | Good | Good | Entirety is | ◯ | Good | Good | Entirety is | ◯ |
| Embodiment | | | melted | | | | melted | |
| 1 | | | | | | | | |
| Illustrative | Good | Good | Entirety is | ◯ | Good | Good | Entirety is | ◯ |
| Embodiment | | | melted | | | | melted | |
| 2 | | | | | | | | |
| Illustrative | Good | Good | Entirety is | ◯ | Good | Good | Entirety is | ◯ |
| Embodiment | | | melted | | | | melted | |
| 3 | | | | | | | | |
| Illustrative | Good | Good | Entirety is | ◯ | Good | Good | Entirety is | ◯ |
| Embodiment | | | melted | | | | melted | |
| 4 | | | | | | | | |
| Illustrative | Good | Good | Entirety is | ◯ | Good | Good | Entirety is | ◯ |
| Embodiment | | | melted | | | | melted | |
| 5 | | | | | | | | |
| Illustrative | Good | Good | Entirety is | ◯ | Good | Good | Entirety is | ◯ |
| Embodiment | | | melted | | | | melted | |
| 6 | | | | | | | | |
| Illustrative | Good | Good | Entirety is | ◯ | Good | Good | Entirety is | ◯ |
| Embodiment | | | melted | | | | melted | |
| 7 | | | | | | | | |
| Comparison | Exposure of | Good | Entirety is | ◯ | Exposure of | Not-yet- | solder ball and | X |
| Example 1 | solder | | melted | | solder | melted solder | not-yet-melted | |
| | particles | | | | particles | particles | solder particles | |
| Comparison | Exposure of | Good | Entirety is | ◯ | Exposure of | Not-yet- | solder ball and | X |
| Example 2 | solder | | melted | | solder | melted solder | not-yet-melted | |
| | particles | | | | particles | particles | solder particles | |

Table 1 shows the result of the evaluation of the above seven types of solder pastes of Illustrative Embodiments 1 to 7 and the two types of solder pastes of Comparison Examples 1 and 2. As can be seen from Table 1, the solder pastes of Illustrative Embodiment 1 to Illustrative Embodiment 7 allow, both in the cases of the coating amount corresponding to the 1005-size chip resistance and the coating amount corresponding to the 0603-size chip resistance, the flux to cover solder particles even during a pre-heating process to allow the entire solder paste to be melted at a peak of the heating. After being cooled, the solder pastes of Illustrative Embodiment 1 to Illustrative Embodiment 7 were entirely melted to show no solder ball. This is due to the fact that the solder pastes of Illustrative Embodiment 1 to Illustrative Embodiment 7 were added with heat-curing polymer (e.g., epoxy resin, polyester resin) or thickener (e.g., carboxy vinyl polymer) so that the flux can cover the surface, of the solder particles even at a pre-heating temperature to prevent the surface of the solder particles from being oxidized.

The solder pastes of Illustrative Embodiment 1 to Illustrative Embodiment 7 included flux in an amount of 8 to 11% by weight. In addition to these types of solder pastes, other solder pastes having various other compositions were, prepared and tested. The result showed that solder paste including a flux amount equal to or lower than 20% by weight can be coated by a conventional screen printing for example and can prevent the surface of the solder particles from being oxidized. It is noted that a lower limit value of the flux was 5% by weight. The test result also showed that an upper limit value of the flux of 15% by weight can further expand the range of print conditions and thus is a desirable range. An upper limit value of the flux of 11% by weight or less can relatively increase the amount of solder alloy powders. This allows, even when a minute amount of solder paste is coated, solder alloy powders to be securely melted to one another during a heating process for solder joint, thus further suppressing a solder ball from being caused.

On the other hand, the solder pastes of Comparison Examples 1 and 2 both have caused the flux to settle at a pre-heating temperature to expose the solder particles to air. This has caused the surface of the solder particles at the uppermost surface layer to be oxidized. The oxidized solder particles were seen in both of the coating amount corresponding to the 1005-size chip resistance and the coating amount corresponding to the 0603-size chip resistance. However, it was observed that the coating amount corresponding to the 1005-size chip resistance caused the entire solder paste to be melted at the peak of the heating. The coating amount corresponding to the 0603-size chip resistance on the other hand caused not-yet-melted solder particles after the peak of the heating and caused a solder ball after the cooling.

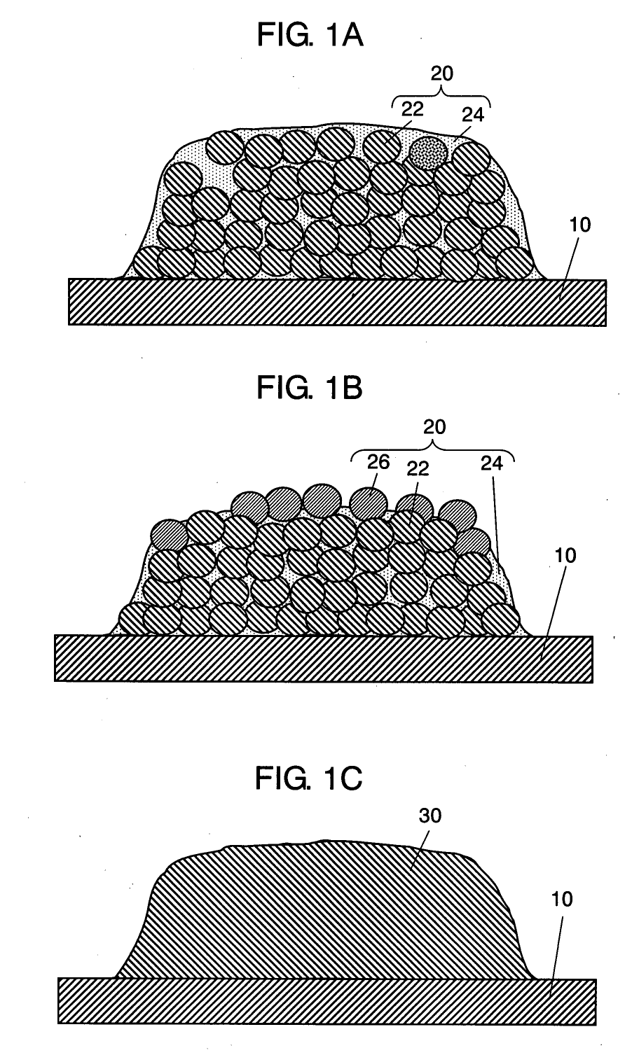

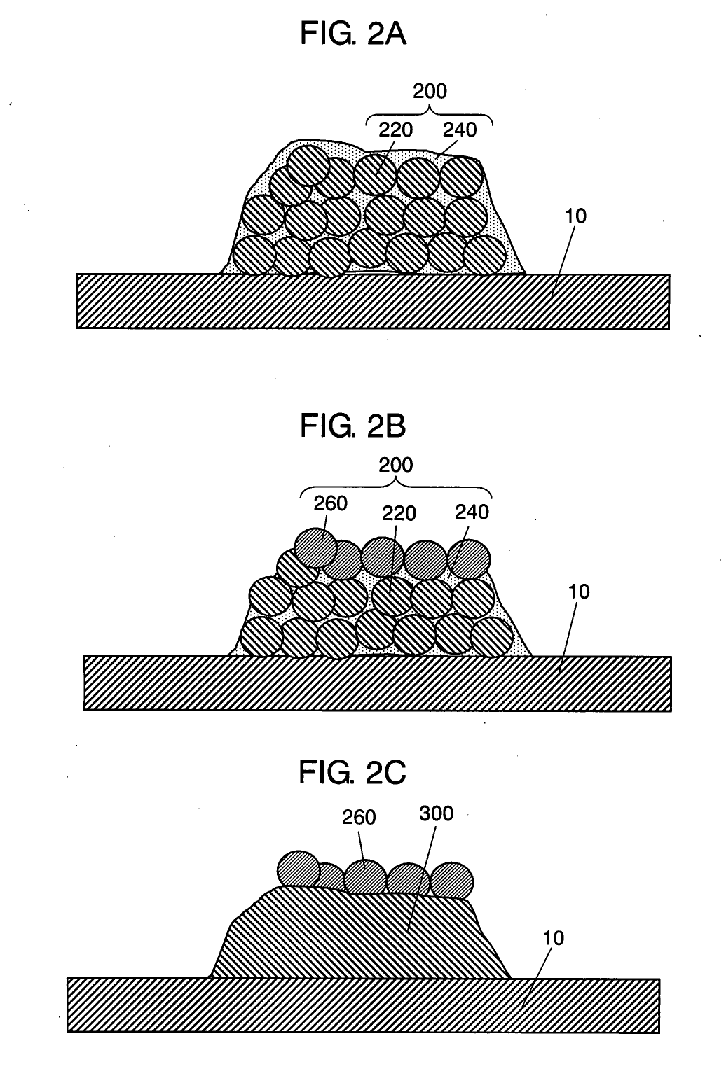

As described above, the solder pastes of Comparison Examples 1 and 2 have caused, depending on a coating amount of the solder paste, solder ball and not-yet-melted solder particles. The reason is assumed in the following section. FIG. 1A to FIG. 1C are a schematic view illustrating the heating behavior of solder paste when the solder paste is coated in a coating amount corresponding to a 1005-size chip component. FIG. 2A to FIG. 2C are a schematic view illustrating the heating behavior of solder paste when the solder paste is coated in a coating amount corresponding to a 0603-size chip component. In FIG. 1A to FIG. 2C, electrode terminal 10 of the print wiring substrate and solder pastes use the same material but the solder pastes are coated in different coating amounts. Specifically, solder pastes 200 shown in FIG. 2A to FIG. 2C are coated in a coating amount about ¼ smaller than those of solder paste 20 shown in FIG. 1A to FIG. 1C.

FIG. 1A and FIG. 2A are a schematic cross sectional view illustrating solder pastes 20 and 200 coated onto electrode terminal 10, respectively. Solder pastes 20 and 200 on electrode terminal 10 are composed of solder particles 22 and 220 and fluxes 24 and 240, respectively.

FIG. 1B and FIG. 2B are a schematic view illustrating solder pastes 20 and 200 pre-heated at the same temperature. After the pre-heating, the coating amount corresponding to the 1005-size chip resistance causes, as shown in FIG. 1B, flux 24 to settle and vaporize to expose solder particles 22 at the surface to air, causing the surface of solder particles 22 to be oxidized. This causes the surface of solder paste 20 to have solder particles 26 having an oxidized film. However, when solder paste 20 is heated to a peak temperature at which the solder is melted, not-yet-oxidized solder particles 22 therein are melted and are integrated to one another. This is presumably caused by a process in which the solder particles are melted to one another and are integrated to cause a volumetric expansion having energy to break the oxidized film at the surface of solder particle 26 to melt the entirety. This prevents a solder ball and allows the entirety to be melted in a uniform manner.

FIG. 1C is a schematic view illustrating the melting status of the solder when the solder is heated to a peak temperature at which the solder melts. As can be seen from FIG. 1C, solder 30 is melted and integrated uniformly.

The coating amount corresponding to the 0603-size chip resistance on the other hand causes, as shown in FIG. 2B, the flux to settle and vaporize during the pre-heating to expose solder particle 220 at the surface to air, causing the surface to be oxidized. Thus, the surface of solder paste 200 has thereon solder particles 260 having an oxidized film. Even when solder paste 200 is heated to a peak temperature, an amount of not-oxidized solder particles 220 is small and thus solder particles 220 are melted and integrated to cause volumetric expansion having small energy. This energy is not enough to break the oxidized film at the surface of solder particles 260 having an oxidized film. This presumably causes a is solder ball.

FIG. 2C is a schematic view illustrating the melting status of the solder when the solder is heated to a peak temperature at which the solder melts. As can be seen from FIG. 2C, the melting process leaves not only solder 300 but also solder balls.

As described above, when the solder pastes of Comparison Examples 1 and 2 are coated in a small coating amount, not-yet-melted solder particles are left and result in solder balls. In, contrast with this, the solder pastes of Illustrative Embodiment 1 to Illustrative Embodiment 7 do not cause a solder ball. This is enabled by the fact that the flux covered the solder particles at a pre-heating temperature to prevent the oxidation. The above results show that, in order to subject a minute electronic component such as a 0603 size electronic component to the solder joint with a print wiring substrate while preventing a solder ball, the flux may be provided with a high temperature retention property so that the surface of the solder particles can be covered by the flux at a pre-heating temperature.

As is clear from the above description, the solder paste of the present invention uses the flux having a high temperature retention property by which the flux can cover the surface of the solder particles even at a pre-heating temperature. Thus, even the solder particles at the uppermost surface of the solder paste can be blocked from air and the surface of the solder particles can be prevented from is being oxidized. This allows, even when the solder paste is coated in a very small coating amount, the solder paste can have a stable melting status and can suppress a solder ball from being caused. Thus, a minute electronic component can be packaged onto a print wiring substrate with a high density.

It is noted that, in order to provide the flux with a high temperature retention property, not only heat-curing polymer material or thickener may be added to the flux but also conventional flux may be used in an increased amount. However, when conventional flux is used, it is required to select a suitable printing method for coating solder paste to the surface of an electrode terminal of a print wiring substrate depending on the amount of the flux included in the solder paste.

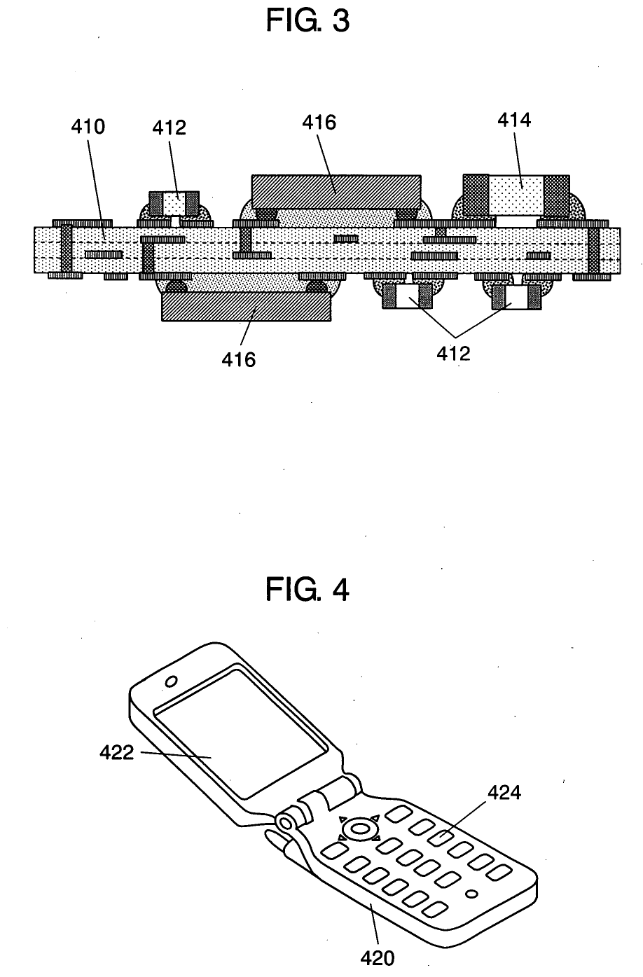

FIG. 3 is a cross-sectional view illustrating an electronic circuit substrate for a mobile phone prepared by using the solder paste of Illustrative Embodiment 1. This electronic circuit substrate is structured so that 0603-size chip component 412, 1005-size chip component 414, and semiconductor chip 416 are packaged on multilayer wiring substrate 410 made of resin base material. It is noted that FIG. 3 shows only three 0603 size chip components 412, one 1005-size chip component 414, and two semiconductor chips 416. However, an actual electronic circuit substrate is packaged, although not shown, with more chip components and also packaged with a 1608 size chip component, a connector, and a filter element for example. Multilayer wiring substrate 410 also includes, as shown in FIG. 3, an inner package conductor, an inner via, and a penetrating conductor for example.

The electronic circuit substrate as described above frequently uses a 0603-size chip component. The use of the solder paste described in Illustrative Embodiment 1 of the present invention has caused no short circuit failure due to a solder ball or the like or no connection failure or the like. It is noted that the solder pastes of Illustrative Embodiments 2 to 7 also provided the same result.

It is noted that a bare chip of semiconductor chip 416 also may be packaged with an element having various functions (e.g., memory, control LSI) or also may be packaged with a packaged element. These packagings can use, depending on the shape of a semiconductor chip, an optimal method such as the shown flip chip method, a wire bonding method, or a packaging method using a ball grid array. Furthermore, a semiconductor chip also may be connected to a multilayer wiring substrate without the solder paste of the present invention and with conductive adhesive agent or anisotropic conductive resin for example.

FIG. 4 is a perspective view illustrating a mobile phone using this electronic circuit substrate. This mobile phone is structured so that button 424 having various functions and display element 422 are arranged on foldable chassis 420 and chassis 420 includes therein the electronic circuit substrate shown in FIG. 3. This mobile phone causes no short circuit failure or defective connection of the electronic circuit substrate and provides a high production yield and high reliability.

### INDUSTRIAL APPLICABILITY

The solder paste can prevent, when a minute-size passive component or a semiconductor integrated circuit element having a small terminal pitch is soldered by the solder paste, the solder particles from being oxidized and can provide, even when the solder paste is used in a very small amount, the solder joint having high reliability. Thus, the solder paste is effective in a circuit substrate field in which a minute-size electronic component is solder-joined to a substrate.

1. Solder paste obtained by mixing solder alloy powders with flux, wherein:
the flux has, at a pre-heating temperature in a heating/melting step, a high temperature retention property by which the flux covers the surface of the solder alloy powders.

2. The solder paste according to claim 1, wherein the flux is pre-heated to have a viscosity that is equal to or higher than the viscosity at a room temperature.

3. The solder paste according to claim 1, wherein the flux includes heat-curing polymer material.

4. The solder paste according to claim 3, wherein the heat-curing polymer material is any of polyester resin, methyl methacrylate resin, epoxy resin, polystyrene resin, phenol resin, and drying oil.

5. The solder paste according to claim 1, wherein the flux has a viscosity at 140 to 180 degrees that is equal to or higher than of 70% of the viscosity at a room temperature.

6. The solder paste according to claim 5, wherein the flux includes thickener including polymer having a thixotropic nature.

7. The solder paste according to claim 6, wherein:
the polymer is at least one of carboxy vinyl polymer, alginate sodium, propylene glycol alginate, ethyl cellulose, carboxymethylcellulose, synthetic sodium magnesium silicate, dimethyl distearyl ammonium hectolite, sodium polyacrylate, hydroxy ethyl cellulose, and hydroxy propyl methylcellulos.

8. The solder paste according to claim 1, wherein:
the solder paste includes the flux in an amount of 20% by weight or smaller.

9. The solder paste according to claim 1, wherein:
the solder alloy powders are made of any of Sn—Ag—Cu base alloy, Sn—Ag—In—Bi base alloy, Sn—Zn—Bi base alloy, and Sn—Ag—Cu—Bi base alloy.

10. An electronic device including a circuit substrate packaged with an electronic component, wherein:
solder paste for solder-joining the electronic component to the circuit substrate is the solder paste obtained by mixing solder alloy powders with flux, wherein:
the flux has, at a pre-heating temperature in a heating/melting step, a high temperature retention property by which the flux covers the surface of the solder alloy powders.
